(19) United States
(12) Patent Application Publication
(10) Pub. No.: US 2020/0385017 A1
(43) Pub. Date: Dec. 10, 2020

(54) VEHICLE CONTROL DEVICE AND VEHICLE CONTROL METHOD

(71) Applicant: HONDA MOTOR CO., LTD., Tokyo (JP)

(72) Inventors: Ichiro Baba, Wako-shi (JP); Yuji Yasui, Wako-shi (JP)

(21) Appl. No.: 16/871,074

(22) Filed: May 11, 2020

(30) Foreign Application Priority Data
May 16, 2019 (JP) 2019-092967

(51) Int. Cl. B60W 60/00; B60W 30/095; B60W 30/18; B60W 40/06; G06K 9/00

(52) U.S. Cl. CPC B60W 60/0011; B60W 60/0015; B60W 30/0956; B60W 2520/06; B60W 40/06; G06K 9/00805; G06K 9/00798; B60W 30/18163

(57) ABSTRACT

A vehicle control device includes an obstacle recognizer configured to recognize an obstacle which is located near a vehicle and a target trajectory generator configured to generate a target trajectory in which the vehicle is to travel repeatedly with a predetermined cycle. The target trajectory generator is configured to generate the target trajectory such that a first change which is an amount of change in a road width direction from the target trajectory which is generated in a previous cycle during repeated execution and a second change which is an amount of change of a direction with respect to a direction directed from the vehicle to a point a predetermined distance away on the target trajectory between the previous cycle and a current cycle are decreased.

### CROSS-REFERENCE TO RELATED APPLICATION

Priority is claimed on Japanese Patent Application No. 2019-092967, filed May 16, 2019, the content of which is incorporated herein by reference.

### BACKGROUND

### Field of the Invention

The invention relates to a vehicle control device and a vehicle control method.

### Description of Related Art

Research and commercialization of automated traveling of vehicles (hereinafter automated driving) has progressed. In automated driving, automatic generation of a target trajectory based on a situation in a traveling direction is performed.

In this regard, a vehicle control device including a first setter that sets a first potential for a plurality of subareas into which a road area is divided on the basis of the road area, a second setter that sets a second potential for the subareas on the basis of a nearby object detected by a detector, an evaluator that derives an index value obtained by evaluating a potential of a subarea of interest out of the plurality of subareas on the basis of the first potential and the second potential set for the subarea of interest and prediction information generated for a nearby subarea selected from the vicinity of the subarea of interest, and a selector that selects one or more subareas in a traveling direction of a vehicle from the plurality of subareas on the basis of the index value derived by the evaluator has been disclosed (Japanese Unexamined Patent Application, First Publication No. 2019-34627)

### SUMMARY

In the related art, evaluation for each point included in a trajectory may not be sufficiently reflected. Accordingly, a target trajectory may not be flexibly generated in various scenes.

The invention is made in consideration of the above circumstances and an object thereof is to provide a vehicle control device and a vehicle control method that can flexibly generate a target trajectory in various scenes.

A vehicle control device and a vehicle control method according to the invention employ the following configurations.

(1) A vehicle control device according to an aspect of the invention includes: an obstacle recognizer configured to recognize an obstacle which is located near a vehicle; and a target trajectory generator configured to generate a target trajectory in which the vehicle is to travel repeatedly with a predetermined cycle, wherein the target trajectory generator is configured to generate the target trajectory such that a first change which is an amount of change in a road width direction from the target trajectory which is generated in a previous cycle during repeated execution and a second change which is an amount of change of a direction with respect to a direction directed from the vehicle to a point a predetermined distance away on the target trajectory between the previous cycle and a current cycle are decreased.

(2) In the aspect of (1), the target trajectory generator may be configured to generate the target trajectory such that a distance in the road width direction between candidate points adjacent to each other in a road length direction out of candidate points which segments the target trajectory at pitches of a predetermined distance is decreased.

(3) In the aspect of (1), the vehicle control device may further include: a first index deriver configured to derive a first index which has a more negative value as the vehicle becomes closer to the recognized obstacle for each of a plurality of candidate points in a traveling direction of the vehicle; a second index deriver configured to derive a second index which has a more positive value as the vehicle becomes closer to a recommended trajectory which is set in a predetermined rule for each of the plurality of candidate points in the traveling direction of the vehicle; and a third index deriver configured to derive a third index which is obtained by evaluating a shape of a temporary trajectory connecting the plurality of candidate points in the road length direction on the basis of at least the first change and the second change, and the target trajectory generator may be configured to generate a temporary trajectory in which a score based on the first index and the second index correlated with a plurality of candidate points included in the temporary trajectory and the third index derived for the temporary trajectory has a positive value out of a plurality of the temporary trajectories as the target trajectory.

(4) A vehicle control device according to another aspect of the invention includes: an obstacle recognizer configured to recognize an obstacle which is located near a vehicle; a first index deriver configured to derive a first index which has a more negative value as the vehicle becomes closer to the recognized obstacle for each of a plurality of candidate points in a traveling direction of the vehicle; a second index deriver configured to derive a second index which has a more positive value as the vehicle becomes closer to a recommended trajectory which is set in a predetermined rule for each of the plurality of candidate points in the traveling direction of the vehicle; a third index deriver configured to derive a third index which is obtained by evaluating a shape of a temporary trajectory connecting the plurality of candidate points in a road length direction; and a target trajectory generator configured to generate a target trajectory in which the vehicle is to travel, wherein the target trajectory generator is configured to generate a temporary trajectory in which a score based on the first index and the second index correlated with a plurality of candidate points included in the temporary trajectory and the third index derived for the temporary trajectory has a positive value out of a plurality of the temporary trajectories as the target trajectory.

(5) In the aspect of (4), the third index deriver may be configured to derive the third index such that the third index has a more positive value as a distance in a road width direction between candidate points adjacent to each other in the road length direction becomes less for the plurality of candidate points included in the temporary trajectory.

(6) In the aspect of (4), the target trajectory generator may be configured to generate the target trajectory repeatedly with a predetermined cycle, and the third index deriver may be configured to derive the third index such that the third index has a more positive value as a distance in a road width direction between corresponding points in the road length direction in the target trajectory which is generated in a previous cycle and the temporary trajectory becomes less.

(7) In the aspect of (4), the target trajectory generator may be configured to generate the target trajectory repeatedly with a predetermined cycle, and the third index deriver may be configured to derive the third index such that the third index has a more positive value as change of a slope of a straight line connecting a position of the vehicle at a time point of generation of the temporary trajectory and a predetermined-numbered candidate point form a candidate point closest to the vehicle in the temporary trajectory between a previous cycle and a current cycle becomes less.

(8) In the aspect of (4), the third index deriver may be configured not to derive the third index from a temporary trajectory in which a distance in a road width direction between candidate points adjacent to each other in the road length direction is greater than a threshold value.

(9) In the aspect of (1), the target trajectory generator may be configured to move one of two candidate points in which a distance in the road width direction is greater than a threshold value in the road width direction such that the distance is not greater than the threshold value when the distance in the road width direction between candidate points which constitute the generated target trajectory and are adjacent to each other in a road length direction is greater than the threshold value.

(10) In the aspect of (9), the target trajectory generator may be configured to set a search start point which is used to ascertain whether the distance in the road width direction between candidate points adjacent to each other in the road length direction is greater than the threshold value to a trajectory point which is farthest from the vehicle in the road width direction out of trajectory points constituting the target trajectory.

(11) A vehicle control method according to another aspect of the invention is a vehicle control method of causing a computer mounted in a vehicle to perform: recognizing an obstacle which is located near the vehicle; generating a target trajectory in which the vehicle is to travel repeatedly with a predetermined cycle; and generating the target trajectory such that a first change which is an amount of change in a road width direction from the target trajectory which is generated in a previous cycle during the repeated generating and a second change which is an amount of change of a direction with respect to a direction directed from the vehicle to a point a predetermined distance away on the target trajectory between the previous cycle and a current cycle are decreased.

(12) A vehicle control method according to another aspect of the invention is a vehicle control method of causing a computer mounted in a vehicle to perform: recognizing an obstacle which is located near the vehicle; deriving a first index which has a more negative value as the vehicle becomes closer to the recognized obstacle for each of a plurality of candidate points in a traveling direction of the vehicle; deriving a second index which has a more positive value as the vehicle becomes closer to a recommended trajectory which is set in a predetermined rule for each of the plurality of candidate points in the traveling direction of the vehicle; deriving a third index which is obtained by evaluating a shape of a temporary trajectory connecting the plurality of candidate points in a road length direction; generating a target trajectory in which the vehicle is to travel; and generating a temporary trajectory in which a score based on the first index and the second index correlated with a plurality of candidate points included in the temporary trajectory and the third index derived for the temporary trajectory has a positive value out of a plurality of the temporary trajectories as the target trajectory at the time of generating the target trajectory.

According to the aspects of (1) to (12), it is possible to flexibly generate a target trajectory in various scenes.

According to the aspects of (8) to (10), it is possible to further decrease a probability of sudden turning of a vehicle.

### BRIEF DESCRIPTION OF THE DRAWINGS

FIG. 1 is a diagram illustrating a configuration of a vehicle system employing a vehicle control device according to an embodiment;

FIG. 2 is a diagram illustrating functional configurations of a first controller and a second controller;

FIG. 3 is a diagram illustrating candidate points, a first index, and a second index;

FIG. 4 is a diagram illustrating a distribution of the first index and a distribution of the second index in a cross-section taken along line 4-4 in FIG. 3;

FIG. 5 is a diagram illustrating an example of a method of calculating a first index R;

FIG. 6 is a diagram illustrating an example of a method of calculating a second index B;

FIG. 7 is a diagram illustrating a target trajectory according to a comparative example;

FIG. 8 is a (first) diagram illustrating a third index;

FIG. 9 is a (second) diagram illustrating the third index;

FIG. 10 is a diagram illustrating a target trajectory which is generated for a plurality of obstacles;

FIG. 11 is a flowchart illustrating an example of a process flow which is performed by the first controller;

FIG. 12 is a flowchart illustrating an example of a process flow which is performed by the first controller according to a second embodiment;

FIG. 13 is a diagram illustrating a process flow which his performed by a target trajectory generator according to a third embodiment;

FIG. 14 is a flowchart illustrating an example of a process flow which is performed by the first controller according to a third embodiment; and

FIG. 15 is a diagram illustrating an example of a hardware configuration of an automated driving control device according to an embodiment.

### DESCRIPTION OF EMBODIMENTS

Hereinafter, a vehicle control device and a vehicle control method according to an embodiment of the invention will be described with reference to the accompanying drawings.

### First Embodiment

Entire Configuration

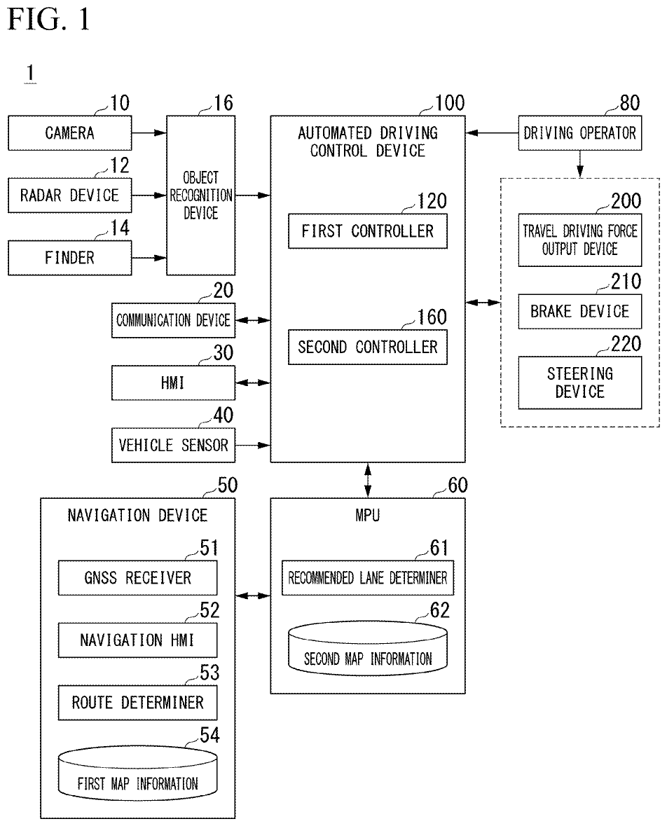

FIG. 1 is a diagram illustrating a configuration of a vehicle system employing a vehicle control device according to an embodiment. A vehicle in which the vehicle system 1 is mounted is, for example, a vehicle with two wheels, three wheels, or four wheels and a drive source thereof is an internal combustion engine such as a diesel engine or a gasoline engine, an electric motor, or a combination thereof. The electric motor operates using electric power which is generated by a power generator connected to the internal combustion engine or electric power which is discharged from a secondary battery or a fuel cell.

The vehicle system 1 includes, for example, a camera 10, a radar device 12, a finder 14, an object recognition device 16, a communication device 20, a human-machine interface (HMI) 30, a vehicle sensor 40, a navigation device 50, a map positioning unit (MPU) 60, a driving operator 80, an automated driving control device 100, a travel driving force output device 200, a brake device 210, and a steering device 220. These devices or instruments are connected to each other via a multiplex communication line such as a controller area network (CAN) communication line, a serial communication line, a radio communication network, or the like. The elements illustrated in FIG. 1 are only an example and some of the elements may be omitted or another element may be added thereto.

The camera 10 is, for example, a digital camera using a solid-state imaging device such as a charge-coupled device (CCD) or a complementary metal oxide semiconductor (CMOS). The camera 10 is attached to an arbitrary position on a vehicle (hereinafter referred to as a host vehicle M) in which the vehicle system 1 is mounted. When a scene in front of the vehicle M is imaged, the camera 10 is attached to an upper part of a front windshield, a rear surface of a rearview mirror, or the like. The camera 10 images surroundings of the host vehicle M, for example, periodically and repeatedly. The camera 10 may be a stereoscopic camera.

The radar device 12 radiates radio waves such as millimeter waves to the surroundings of the host vehicle M and detects at least a position (a distance and a direction) of an object by detecting radio waves (reflected waves) reflected by the object. The radar device 12 is attached to an arbitrary position on the host vehicle M. The radar device 12 may detect a position and a speed of an object using a frequency modulated continuous wave (FM-CW) method.

The finder 14 is a Light Detection And Ranging device (LIDAR). The finder 14 applies light to the surroundings of the host vehicle M and measures scattered light. The finder 14 detects a distance to an object on the basis of a time from emission of light to reception of light. The light which is applied is, for example, a pulse-like laser beam. The finder 14 is attached to an arbitrary position on the host vehicle M.

The object recognition device 16 performs a sensor fusion process on results of detection from some or all of the camera 10, the radar device 12, and the finder 14 and recognizes a position, a type, a speed, and the like of an object. The object recognition device 16 outputs the result of recognition to the automated driving control device 100. The object recognition device 16 may output the results of detection from the camera 10, the radar device 12, and the finder 14 to the automated driving control device 100 without any change. The object recognition device 16 may be omitted from the vehicle system 1.

The communication device 20 communicates with another vehicle near the host vehicle M, for example, using a cellular network, a Wi-Fi network, Bluetooth (registered trademark), or dedicated short range communication (DSRC), or various server devices via a radio base station.

The HMI 30 presents various types of information to an occupant of the host vehicle M and receives an input operation from the occupant. The HMI 30 includes various display devices, speakers, buzzers, touch panels, switches, and keys.

The vehicle sensor 40 includes a vehicle speed sensor that detects a speed of the host vehicle M, an acceleration sensor that detects acceleration, a yaw rate sensor that detects an angular velocity around a vertical axis, and a direction sensor that detects a direction of the host vehicle M.

The navigation device 50 includes, for example, a global navigation satellite system (GNSS) receiver 51, a navigation HMI 52, and a route determiner 53. The navigation device 50 stores first map information 54 in a storage device such as a hard disk drive (HDD) or a flash memory. The GNSS receiver 51 identifies a position of the host vehicle M on the basis of signals received from GNSS satellites. The position of the host vehicle M may be identified or complemented by an inertial navigation system (INS) using the output of the vehicle sensor 40. The navigation HMI 52 includes a display device, a speaker, a touch panel, and keys. All or a part of the navigation HMI 52 may be shared by the HMI 30. For example, the route determiner 53 determines a route (hereinafter a route on a map) from the position of the host vehicle M identified by the GNSS receiver 51 (or an input arbitrary position) to a destination input by an occupant using the navigation HMI 52 with reference to the first map information 54. The first map information 54 is, for example, information in which road shapes are expressed by links indicating roads and nodes connected by the links. The first map information 54 may include a curvature of a road or point of interest (POI) information. The route on a map is output to the MPU 60. The navigation device 50 may perform guidance for a route using the navigation HMI 52 on the basis of the route on a map. The navigation device 50 may be realized, for example, by a function of a terminal device such as a smartphone or a tablet terminal which is carried by an occupant. The navigation device 50 may transmit a current position and a destination to a navigation server via the communication device 20 and may acquire a route which is equivalent to the route on a map from the navigation server.

The MPU 60 includes, for example, a recommended lane determiner 61 and stores second map information 62 in a storage device such as an HDD or a flash memory. The recommended lane determiner 61 divides the route on a map supplied from the navigation device 50 into a plurality of blocks (for example, every 100 [m] in a vehicle traveling direction) and determines a recommended lane for each block with reference to the second map information 62. The recommended lane determiner 61 determines in which lane from the leftmost the vehicle will travel. When there is a branching point in the route on a map, the recommended lane determiner 61 determines a recommended lane such that the host vehicle M travels on a rational route for traveling to a branching destination.

The second map information 62 is map information with higher precision than the first map information 54. The second map information 62 includes, for example, information of the center of a lane or information of boundaries of a lane. The second map information 62 may include road information, traffic regulation information, address information (addresses and postal codes), facility information, and phone number information. The second map information 62 may be updated from time to time by communicating with another device using the communication device 20.

The driving operator 80 includes, for example, an accelerator pedal, a brake pedal, a shift lever, a steering wheel, a deformed steering, a joystick, and other operators. A sensor that detects an amount of operation or performing of an operation is attached to the driving operator 80, and results of detection thereof are output to some or all of the automated driving control device 100, the travel driving force output device 200, the brake device 210, and the steering device 220.

The automated driving control device 100 is an example of a vehicle control device. The automated driving control device 100 includes, for example, a first controller 120 and a second controller 160. The first controller 120 and the second controller 160 are realized, for example, by causing a hardware processor such as a central processing unit (CPU) to execute a program (software). Some or all of such elements may be realized in hardware (which includes circuitry) such as a large scale integration (LSI), an application specific integrated circuit (ASIC), or a field-programmable gate array (FPGA), or a graphics processing unit (GPU) or may be realized in cooperation of software and hardware. The program may be stored in a storage device such as an HDD or a flash memory of the automated driving control device 100 (a storage device including a non-transitory storage medium) in advance, or may be installed in the HDD or the flash memory of the automated driving control device 100 by storing the program in a detachable storage medium (the non-transitory storage medium) such as a DVD or a CD-ROM and attaching the storage medium to a drive device.

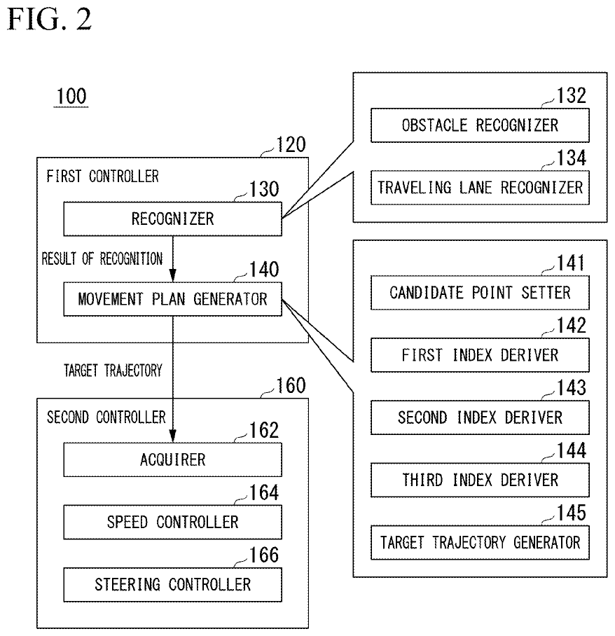

FIG. 2 is a diagram illustrating functional configurations of the first controller and the second controller. The first controller 120 includes, for example, a recognizer 130 and a movement plan generator 140. The first controller 120 is realized, for example, by an artificial intelligence function and a function using a function based on artificial intelligence (AI) and a function based on a predetermined model in cooperation. For example, a function of “recognizing a crossing” may be embodied by performing recognition of a crossing based on deep learning or the like and recognition based on predetermined conditions (such as signals which can be pattern-matched and road signs) in cooperation, scoring both recognitions, and comprehensively evaluating both recognitions. Accordingly, reliability of automated driving is secured.

The recognizer 130 includes, for example, an obstacle recognizer 132 and a traveling lane recognizer 134. The obstacle recognizer 132 recognizes states such as a position, a speed, and acceleration of an obstacle near the host vehicle M on the basis of information which is input from the camera 10, the radar device 12, and the finder 14 via the object recognition device 16. For example, a position of an obstacle is recognized as a position in an absolute coordinate system with an origin set to a representative point of the host vehicle M (such as the center of gravity or the center of a drive shaft) and is used for control. A position of an object may be expressed as a representative point such as the center of gravity or a corner of the object or may be expressed as a drawn area. A “state” of an object may include an acceleration or a jerk of the object or a “moving state” (for example, whether lane change is being performed or whether lane change is going to be performed) thereof.

The traveling lane recognizer 134 recognizes, for example, a relative position of a lane (a traveling lane) in which the host vehicle M is traveling with respect to the host vehicle M. For example, the traveling lane recognizer 134 recognizes the traveling lane by comparing a pattern of road markings near the host vehicle M which are recognized from an image captured by the camera 10 with a pattern of road markings (for example, arrangement of a solid line and a dotted line) which are acquired from the second map information 62. The recognizer 130 may recognize the traveling lane by recognizing a traveling road boundary (a road boundary) including road markings, edges of a roadside, a curbstone, a median, and a guard rail as well as the road markings. In this recognition, the position of the host vehicle M acquired from the navigation device 50 and the result of processing from the INS may be considered.

The traveling lane recognizer 134 recognizes a position or a direction of the host vehicle M with respect to a traveling lane at the time of recognition of the traveling lane. The traveling lane recognizer 134 may recognize, for example, separation of a reference point of the host vehicle M from the lane center and an angle of the traveling direction of the host vehicle M with respect to a line formed by connecting the lane centers as the position and the direction of the host vehicle M relative to the traveling lane. Instead, the traveling lane recognizer 134 may recognize a position of the reference point of the host vehicle M relative to one side line of the traveling lane (a road marking or a road boundary) or the like as the position of the host vehicle M relative to the traveling lane.

The movement plan generator 140 includes, for example, a candidate point setter 141, a first index deriver 142, a second index deriver 143, a third index deriver 144, and a target trajectory generator 145. Some or all of the candidate point setter 141, the first index deriver 142, the second index deriver 143, and the third index deriver 144 may be included in the recognizer 130.

The movement plan generator 140 generates a target trajectory in which the host vehicle M will travel automatedly (without requiring a driver's operation) in the future such that the host vehicle M travels in a recommended lane which is determined by the recommended lane determiner 61 in principle and copes with surrounding circumstances of the host vehicle M. The target trajectory generator 145 generates the target trajectory on the basis of a first index which is derived by the first index deriver 142, a second index which is derived by the second index deriver 143, and a third index which is derived by the third index deriver 144. Details thereof will be described later.

For example, a target trajectory is expressed by sequentially arranging points (trajectory points) at which a representative point (for example, the center of the front, the center of gravity, or the center between the rear wheels) of the host vehicle M will arrive at intervals of a predetermined distance (for example, about several [m]) in the road length direction. A target speed and target acceleration at intervals of a predetermined sampling time (for example, about below the decimal point [sec]) are added to the target trajectory. Trajectory points may be positions at which the host vehicle M is to arrive at predetermined sampling times every sampling time. In this case, information of the target speed or the target acceleration is expressed by intervals between the trajectory points.

The second controller 160 controls the travel driving force output device 200, the brake device 210, and the steering device 220 such that the host vehicle M passes along the target trajectory generated by the movement plan generator 140 as scheduled.

The second controller 160 includes, for example, an acquirer 162, a speed controller 164, and a steering controller 166. The acquirer 162 acquires information of a target trajectory (trajectory points) which is generated by the movement plan generator 140 and stores the acquired information in a memory (not illustrated). The speed controller 164 controls the travel driving force output device 200 or the brake device 210 on the basis of a speed element pertained to the target trajectory stored in the memory. The steering controller 166 controls the steering device 220 on the basis of a curved state of the target trajectory stored in the memory. The processes of the speed controller 164 and the steering controller 166 are embodied, for example, by feed-forward control and feedback control in combination. For example, the steering controller 166 performs feed-forward control based on a curvature of a road in front of the host vehicle M and feedback control based on separation from the target trajectory in combination.

The travel driving force output device 200 outputs a travel driving force (a torque) for allowing the host vehicle to travel to the driving wheels. The travel driving force output device 200 includes, for example, a combination of an internal combustion engine, an electric motor, and a transmission and an electronic control unit (ECU) that controls them. The ECU controls the above-mentioned configuration on the basis of information input from the second controller 160 or information input from the driving operator 80.

The brake device 210 includes, for example, a brake caliper, a cylinder that transmits a hydraulic pressure to the brake caliper, an electric motor that generates a hydraulic pressure in the cylinder, and a brake ECU. The brake ECU controls the electric motor on the basis of the information input from the second controller 160 or the information input from the driving operator 80 such that a brake torque based on a braking operation is output to vehicle wheels. The brake device 210 may include a mechanism for transmitting a hydraulic pressure generated by an operation of a brake pedal included in the driving operator 80 to the cylinder via a master cylinder as a backup. The brake device 210 may be an electronically controlled hydraulic brake device that controls an actuator on the basis of the information input from the second controller 160 such that the hydraulic pressure of the master cylinder is transmitted to the cylinder.

The steering device 220 includes, for example, a steering ECU and an electric motor. The electric motor changes a direction of turning wheels, for example, by applying a force to a rack-and-pinion mechanism. The steering ECU drives the electric motor on the basis of the information input from the second controller 160 or the information input from the driving operator 80 to change the direction of the turning wheels.

Generation of Target Trajectory

The method of generating a target trajectory will be described below in more detail.

The first index deriver 142 derives a first index R (a risk) that has a more negative value as the vehicle becomes closer to an obstacle recognized by the obstacle recognizer 132 for each of a plurality of candidate points (points) in the traveling direction of the host vehicle M and correlates the derived first index with the corresponding candidate points of the plurality of candidate points. “Correlates” means, for example, being stored as correlated information in the memory. In this embodiment, a plus value is defined as being “negative,” a value close to zero is defined as being “positive,” and a score which will be described later is defined as having a more positive value (a more preferable value) as the value becomes closer to zero, and vice versa. Accordingly, the first index deriver 142 derives the first index R that has a smaller value as the vehicle becomes closer to an obstacle recognized by the obstacle recognizer 132 for each of a plurality of candidate points (points) in the traveling direction of the host vehicle M.

The second index deriver 143 derives a second index B (a benefit) that has a smaller (more positive) value as the vehicle becomes closer to a recommended trajectory which is set in a predetermined rule for each of a plurality of candidate points in the traveling direction of the host vehicle M and correlates the derived second index with the corresponding candidate of the plurality of candidate points.

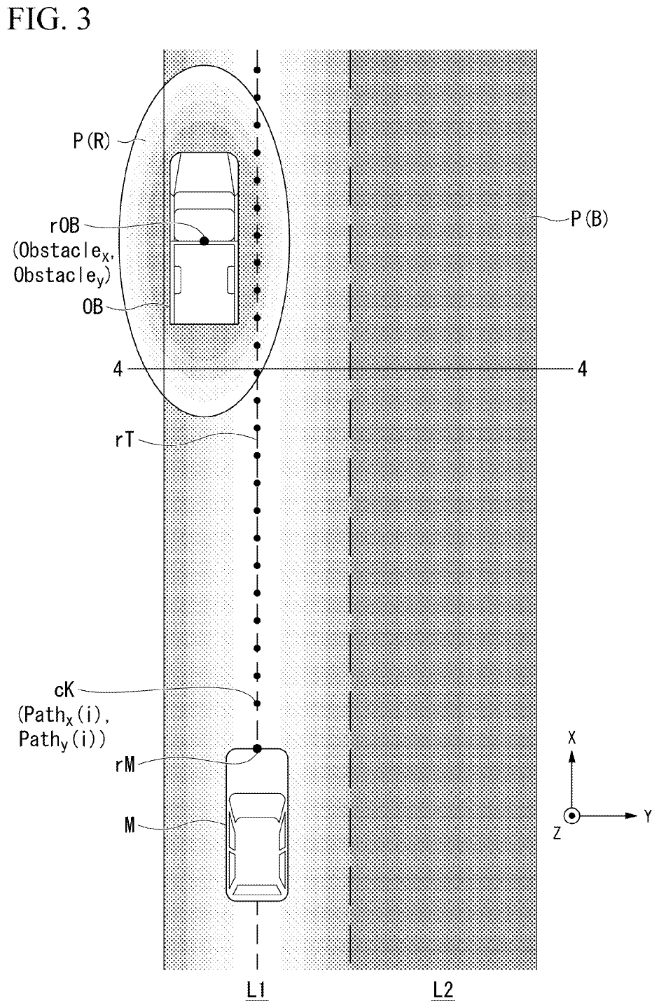

FIG. 3 is a diagram illustrating candidate points, the first index, and the second index. In the drawing, reference sign rT denotes a recommended route. The second index deriver 143 sets the center line of the recommended lane (L1 in FIG. 3) which is determined by the recommended lane determiner 61 as the recommended route rT. The invention is not limited thereto, and the second index deriver 143 may set a line which is biased to one of the right and left sides in the recommended lane as the recommended route rT. In a curved road, the recommended route has a curved shape. When the movement plan generator 140 changes the lane of the host vehicle M, a route which is directed from a certain lane to another adjacent lane may be set as the recommended route rT.

In the drawing, reference sign cK denotes a candidate point. The candidate point setter 141 sets a plurality of candidate points cK on a road in the traveling direction of the host vehicle M such that each candidate point has a width in a road length direction (an X direction) and a road width direction (a Y direction). In the following description, the road length direction is referred to as a longitudinal direction and the road width direction is referred to as a lateral direction. In principle, the candidate point setter 141 sets a plurality of candidate points cK (Pathₓ(i), Path_{y}(i)) at intervals of a predetermined distance from the representative point rM of the host vehicle M on the recommended route rT (where i=1, 2, . . . , N), changes a position in the lateral direction of each candidate point cK by a predetermined width, and comprehensively sets the candidate points cK. The candidate points cK on the recommended route rT may be referred to as a base path. The factor i is, for example, a value which is set in a receding order from the representative point of the host vehicle M. A line connecting the candidate points cK in the longitudinal direction is a candidate for a target trajectory and the candidate points cK constituting the determined target trajectory are trajectory points. As will be described later, the method of setting the candidate points cK is not limited to the searching method in the lateral direction with respect to the base path, and may employ a method of performing searching on the basis of a previous target trajectory.

In the drawing, reference sign OB denotes an obstacle which is recognized by the obstacle recognizer 132, and reference sign P(R) denotes a distribution of the first index R. In the drawing, a dark part represents having a large value. The first index deriver 142 derives the first index R for each candidate point cK with respect to a representative point rOB of the obstacle OB, for example, such that the first index increases as it becomes closer to the representative point rOB and decreases as it becomes further away from the representative point rOB. In the following description, the coordinates of the representative point rOB are expressed as (Obstacleₓ, Obstacle_{y}). The distribution P(R) of the first index R is derived to have an elliptical shape which is longer in the longitudinal direction, for example, in view of a contour line of values. The ratio between a major axis and a minor axis of the ellipse is changed, for example, depending on the length of the obstacle OB in the longitudinal direction. An outer edge line of the ellipse in which the first index R is zero is expressed as eOB.

In the drawing, reference sign P(B) denotes a distribution of the second index B. In the drawing, a dark part represents having a large value. The second index deriver 143 derives the second index B that has a more positive value as it becomes closer to the recommended route rT (or the base path) for each candidate point cK.

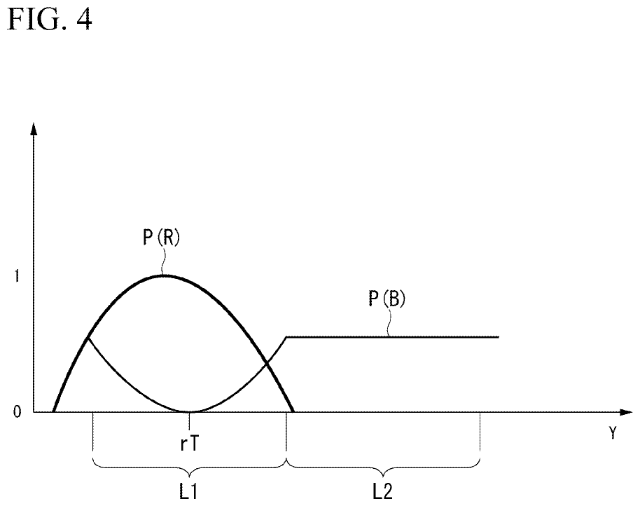

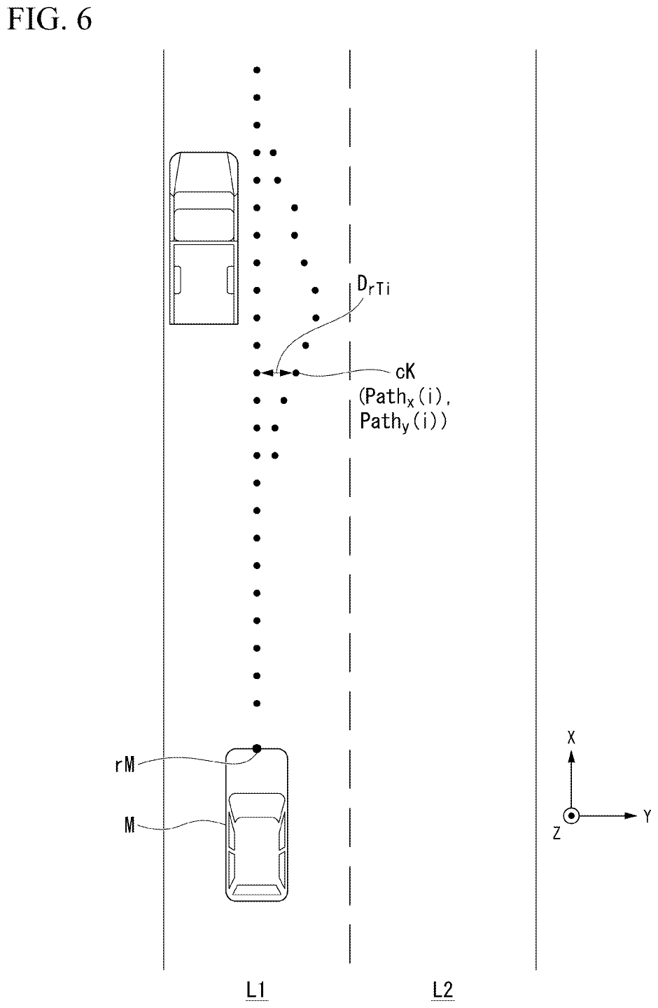

FIG. 4 is a diagram illustrating a distribution P(R) of the first index R and a distribution P(B) of the second index B in a cross-section taken along line 4-4 in FIG. 3. The distribution P(R) of the first index R represents a distribution which has a peak at the position in the lateral direction of the representative point rOB of the obstacle OB, has a smaller value as it becomes further away from the peak, and is zero when it becomes sufficiently far away from the peak. The distribution P(B) of the second index B is a distribution which is zero at the position in the lateral direction of the recommended route rT, has a larger value as it becomes further away from the recommended route rT, and has a constant value in an area of a lane L2 adjacent to a recommended lane L1 (which may also have a larger value as it becomes further away from the recommended route rT in the area of the lane L2 instead: see FIG. 6). The distribution P(B) of the second index B may be set such that it decreases in the vicinity of the center line of the lane L2.

The methods of deriving the first index R and the second index B will be described below in more detail.

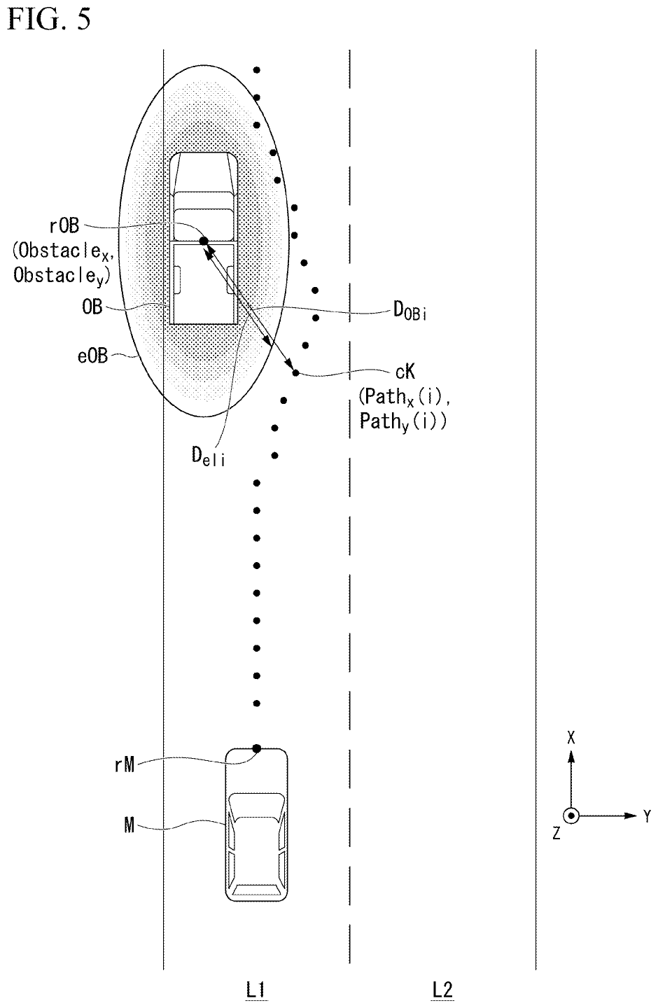

FIG. 5 is a diagram illustrating an example of the method of calculating the first index R. The first index deriver 142 calculates, for example, a distance D_{OBi} between a candidate point cK and the representative point rOB of the obstacle OB and a distance Dₑₗᵢ from the representative point rOB of the obstacle OB to an intersection between a straight line connecting the candidate point cK to the representative point rOB of the obstacle OB and the outer edge line eOB of the ellipse, and derives the first index R such that it is zero when the distance D_{OBi}≥the distance Dₑₗᵢ is satisfied and has a positive value when the distance D_{OBi}<the distance Dₑₗᵢ is satisfied. The distance D_{OBi} is calculated using Expression (1). For example, the first index deriver 142 calculates a flag value Flag(i) which is zero when the distance D_{OBi}≥the distance Dₑₗᵢ is satisfied and which is 1 when the distance D_{OBi}<the distance Dₑₗᵢ is satisfied for each candidate point cK, and calculates a value obtained by multiplying the flag value Flag(i) by a value obtained by dividing a difference between the when the distance Dₑₗᵢ and the distance D_{OBi} by the distance Dₑₗᵢ and normalizing the resultant value as the first index R for each candidate point cK. When a certain temporary trajectory is set and candidate points constituting the temporary trajectory are cK(i) (i=1, 2, . . . , N), the first index R_{Path} for the temporary trajectory is expressed by Expression (2).

D_{OBi}=√{(Pathₓ(i)−Obstacleₓ)²+(Path_{y}(i)−Obstacle_{y})²} (1)

Rₚₐₜₕ=Σᵢ₌₁^{N}{Flag(i)×(Dₑₗᵢ−D_{OBi})/Dₑₗᵢ} (2)

FIG. 6 is a diagram illustrating an example of the method of calculating the second index B. The second index deriver 143 calculates a square of a distance D_{rTi} between a candidate point cK and a candidate point on the base path corresponding to the position in the longitudinal direction as the second index B for each candidate point cK. The distance D_{rTi} is calculated using Expression (3). In the expression, Baseₓ(i) denotes the X coordinate of the i-th candidate point on the base path and Base_{y}(i) denotes the Y coordinate of the i-th candidate point on the base path. When a candidate point cK is detected in the lateral direction with respect to the candidate point cK on the base path, Pathₓ(i)−Baseₓ(i) is zero. When a certain temporary trajectory is set and candidate points constituting the temporary trajectory are cK(i) (i=1, 2, . . . , N), the second index B_{Path} for the temporary trajectory is expressed by Expression (4).

D_{rTi}=√{(Pathₓ(i)−Baseₓ(i))²+(Path_{y}(i)−Base_{y}(i))²} (3)

Bₚₐₜₕ=Σᵢ₌₁^{N}{D_{rTi}} (4)

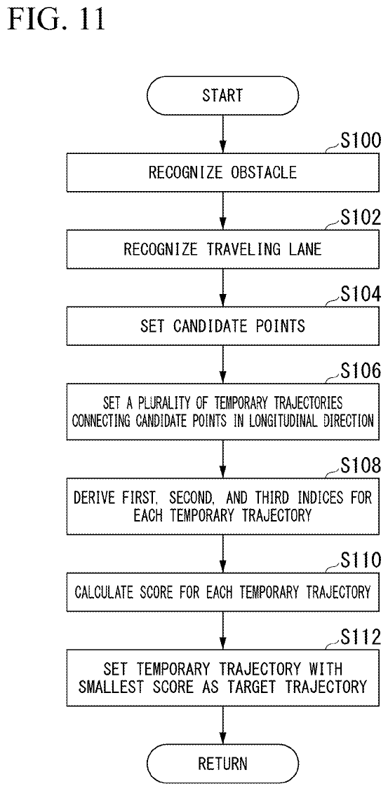

For example, two calculation sequences below can be considered as a calculation sequence including deriving the first index R and the second index B, and any calculation sequence thereof may be employed. A process flow illustrated in FIG. 11 which will be described later is based on the idea of Sequence 2.

Sequence 1

Candidates are comprehensively set→the first index R and the second index B for each candidate point are derived and stored in a memory→a temporary trajectory is set→the first index R and the second index B of each candidate point on the temporary trajectory are read from the memory.

Sequence 2

Candidate points are set→a temporary trajectory is set→the first index R and the second index B for each candidate point on the temporary trajectory are derived.

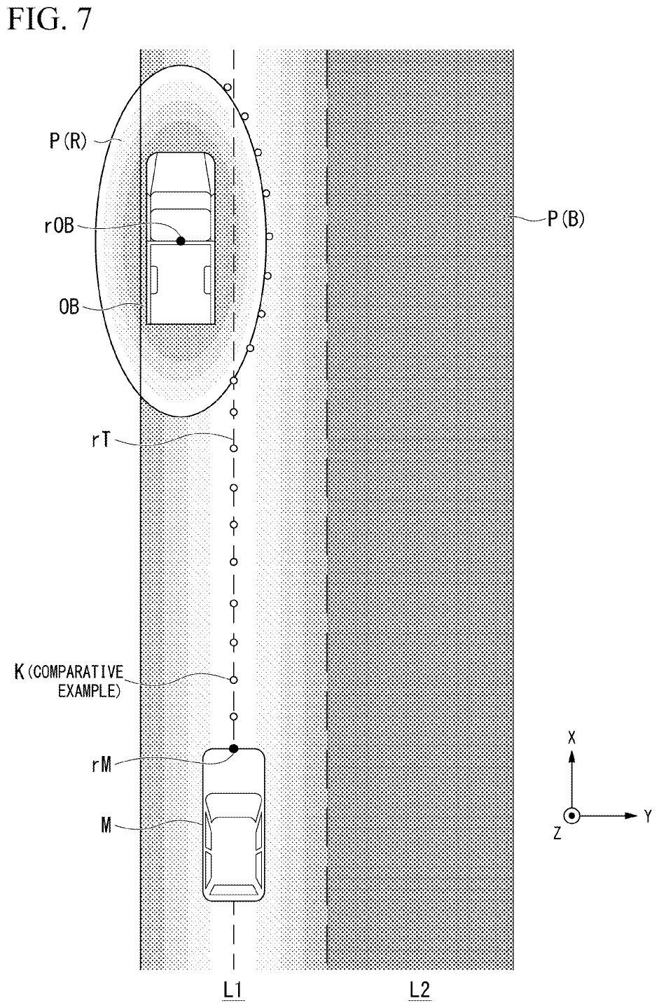

Now, a case in which a target trajectory is generated using only the first index R and the second index B is considered. FIG. 7 is a diagram illustrating a target trajectory according to a comparative example which is generated by selecting a candidate point cK with the smallest sum of the first index R and the second index B out of candidate points cK which are arranged in the lateral direction and connecting the selected candidate points cK in the longitudinal direction. In this case, as illustrated in the drawing, since the target trajectory according to the comparative example including trajectory points K is displaced in a direction in which an obstacle OB is suddenly avoided at a position at which the first index R increases from zero (a position which is tangent to the outer edge of a range in which the distribution P(R) is not zero), the host vehicle M turns suddenly when it travels along the target trajectory.

In consideration of such a problem, the third index deriver 144 derives a third index by evaluating a shape of a temporary trajectory connecting a plurality of candidate points cK in the longitudinal direction. The target trajectory generator 145 generates a target trajectory on the basis of the first index R, the second index B, and the third index, whereby unnecessary sudden turning of the host vehicle M is curbed. The third index deriver 144 generates a temporary trajectory, for example, by comprehensively connecting candidate points cK in the longitudinal direction while candidate points cK which are arranged in the lateral direction are not simultaneously selected. Instead, the temporary trajectory may be set using a desired method, and generation of a temporary trajectory is not particularly limited.

The third index deriver 144 derives the third index by evaluating smoothness of a temporary trajectory on the basis of some or all of three factors of (1) to (3) which will be described below. In the following description, it is assumed that the third index deriver 144 derives the third index on the basis of all of the three factors, and the three factors are referred to as third indices C1, C2, and C3. A factor t means that a control cycle corresponds to a t-th process while the constituents of the first controller 120 perform processes periodically repeatedly. Now, description will be made with a focus on a process of the t-th control cycle.

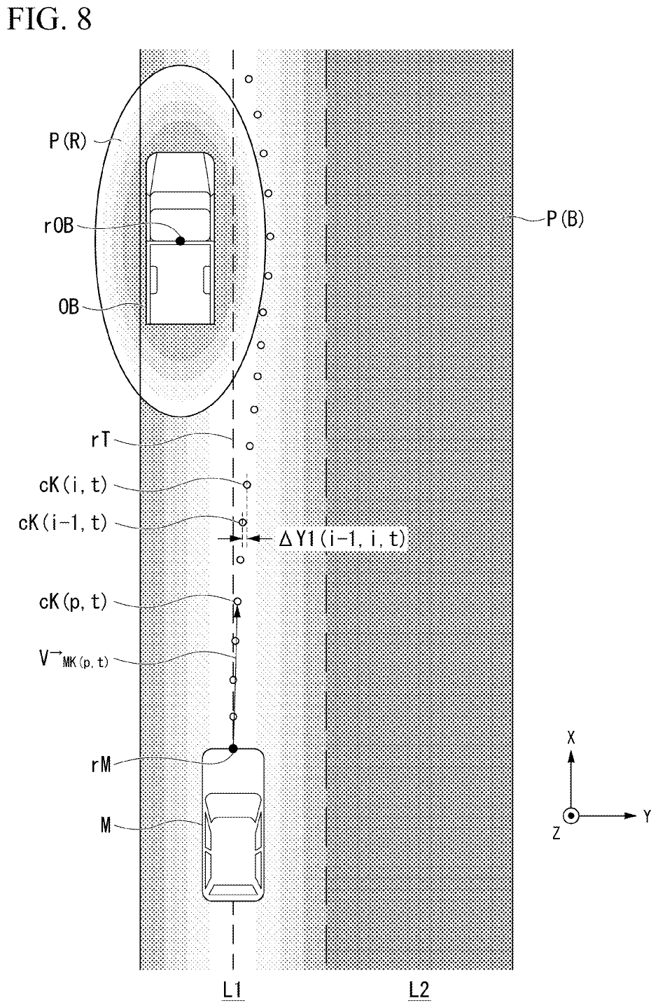

FIG. 8 is a (first) diagram illustrating a third index.

The third index deriver 144 calculates a distance ΔY1(i−1, i, t) in the lateral direction between a candidate point cK(i, t) and a candidate point cK(i−1, t) in the t-th control cycle (the current control cycle) for i=1 to N, and derives a square sum thereof as the third index C1 (Expression (5)). For example, cK(0, t) denotes a representative point rM of the host vehicle M. By decreasing the third index C1, it is possible to set a shape of a target trajectory to a simple shape with a small change in the lateral direction and to curb sudden turning of the host vehicle M.

C1=Σᵢ₌₁^{N}{ΔY1(i−1, i, t)²} (5)

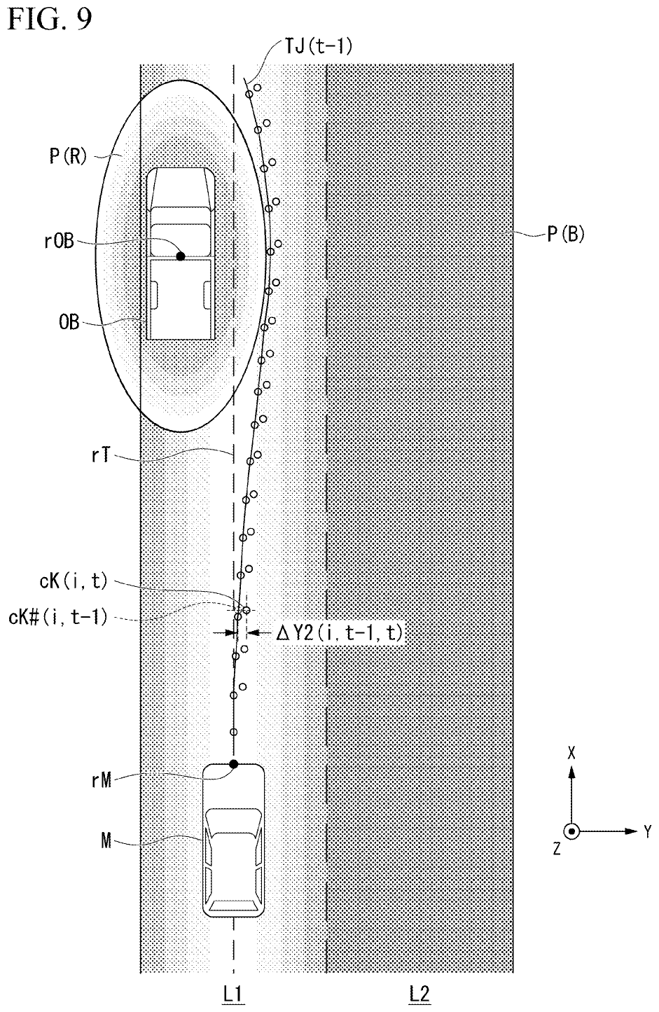

FIG. 9 is a (second) diagram illustrating a third index.

The third index deriver 144 compares a target trajectory TJ(t−c) generated in the (t−C)-th control cycle (a previous control cycle) with candidate points cK(i, t) in the t-th control cycle (the current control cycle), calculates a distance ΔY2(i, t−C, t) in the lateral direction between a position cK#(i, t−C) on the target trajectory TJ(t−C) of which the position in the longitudinal direction matches the candidate point cK(i, t) and the candidate point cK(i, C) for i=1 to N, and derives a square sum thereof as the third index C2 (Expression (6)). Since the target trajectory TJ(t−C) is strictly a set of trajectory points K, a curved line connecting the trajectory points K which are continuous in the longitudinal direction is referred to as a target trajectory TJ(t−C). C is a natural number equal to or greater than 1. In the example illustrated in FIG. 9, C=1 is set. By decreasing the third index C2, it is possible to curb temporal change of a target trajectory which is repeatedly generated with the elapse of time and to curb sudden turning of the host vehicle M.

C2=Σᵢ₌₁^{N}{ΔY2(i−1, i−C, t)²} (6)

FIG. 8 will be referred to for description below.

The third index deriver 144 derives a square of an angle θ(V^{→}_{Mk(p,t-E)}, V^{→}_{MK(p,t)}) which is formed by a vector V^{→}_{MK(p,t)} directed from the representative point rM of the host vehicle M to the p-th candidate point cK(p,t) in the t-th control cycle (the current control cycle) and a vector V^{→}_{MK(p,t-E)} directed from the representative point rM of the host vehicle M to the p-th candidate point cK(p,t−E) in the t−E−th control cycle (the current control cycle) as the third index C3 (Expression (7)). The vectors may be expressed as being “straight lines” but are referred to as vectors. E is a natural number equal to or greater than 1. By decreasing the third index C3, it is possible to curb temporal change of a future point which affects movement of the host vehicle M in the target trajectory and to curb sudden turning of the host vehicle M.

C3=θ² (7)

The target trajectory generator 145 generates a target trajectory on the basis of the first index R, the second index B, and the third index. For example, the target trajectory generator 145 derives a score by inputting the first index R, the second index B, and the third index to a function, and sets a plurality of candidate points cK in a combination with the smallest value as a plurality of trajectory points K constituting the target trajectory. The score is derived, for example, by calculating a weighted sum of the first index R, the second index B, and the third indices C1, C2, and C3 as expressed by Expression (8). Instead, the score may be derived using an arbitrary method such as multiplying together some or all of the first index R, the second index B, and the third indices as long as the gist of the invention is not changed. “The gist of the invention is not changed” means that a trend to decrease the score as the first index R decreases, to decrease the score as the second index B decreases, and to decrease the score as the third index decreases is maintained. Each of w1, w2, w3, w4, and w5 is an arbitrary positive value.

Score(t)=w1×R_{Path}+w2×B_{Path}+w3×C1+w4×C2+w5×C3 (8)

Through the above process, it is possible to decrease a probability of sudden turning of the host vehicle M in comparison with a case in which a target trajectory is generated on the basis of only the first index R and the second index B. Since the process of generating a target trajectory based on only the first index R and the second index B and the process of evaluating the shape of a trajectory are not separated from each other, it is possible to flexibly generate a target trajectory in various scenes.

Here, the number of obstacles is not limited to one. When there are a plurality of obstacles in the traveling direction of the host vehicle M which are recognized by the obstacle recognizer 132, the first index deriver 142 derives the first index R for each obstacle, overlaps the first indices on a road plane, and sums them and sets the sum value as the first index R when both the first index R based on a first obstacle and the first index R based on a second obstacle have values at a certain point. An obstacle is not limited to a stationary object and may be an object which moves at a lower speed than that of the host vehicle M such as a bicycle or a pedestrian. In this case, the first index deriver 142 may derive the first index R in consideration of the elapse of time.

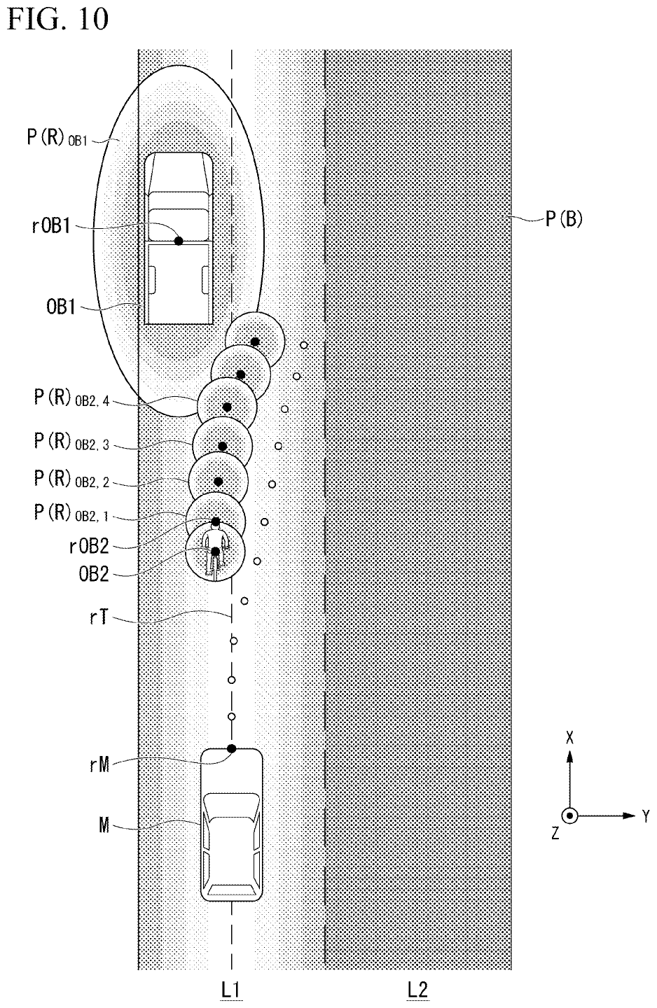

FIG. 10 is a diagram illustrating a target trajectory which is generated for a plurality of obstacles. In the drawing, OB2 denotes a second obstacle (a bicycle), P(R)_{OB1} denotes a distribution of a first index R corresponding to the first obstacle OB1 and P(R)_{OB2} denotes a distribution of a second index R corresponding to the second obstacle OB2. P(R)_{OB1} has an elliptical shape centered on a representative point rOB1 of the obstacle OB1, and P(R)_{OB2} has a circular shape centered on a position of each destination with movement of a representative point rOB2 of the obstacle OB2. The sizes of the distributions are different from each other, and the first index deriver 142 adjusts the sizes of the distributions, for example, on the basis of the sizes of the obstacles OB. The first index deriver 142 estimates that a moving route of the representative point rOB2 traces, for example, the outer edge of the distribution of the first index R for the first obstacle OB1, and estimates the future position of the representative point rOB2 on the basis of the current speed of the obstacle OB2. Distributions P(R)_{OB2,1}, P(R)_{OB2,2}, P(R)_{OB2,3}, P(R)_{OB2,4}, . . . , P(R)_{OB2,j} of the first index R are set for the future positions of the representative points rOB2. The factor j in P(R)_{OB2,j} is the concept of time having the same period as j of a control cycle time. That is, the factor j denotes after how many control cycles the obstacle OB2 has a position.

The first index deriver 142 may simply overlap the distributions P(R)_{OB2,1}, P(R)_{OB2,2}, P(R)_{OB2,3}, P(R)_{OB2,4}, . . . , P(R)_{OB2,j} of the first index R which are generated as described without considering the time and handle the overlapped distributions as the distribution of the first index R of the second obstacle OB2, or may not consider the distribution of the first index R with a small factor j corresponding to the time required, for example, for arrival at a candidate point cK(k) which has a large k, that is, which is far from the host vehicle M, out of the candidate points cK(k) in consideration of movement of the second obstacle OB2. For example, depending on the speed of the host vehicle M, the first index R may be allocated to candidate points cK(k) in k≥Th1 in consideration of only P(R)_{OB2,j} in j≥Th2.

FIG. 11 is a flowchart illustrating an example of a process flow which is performed by the first controller 120. The process flow of the flowchart is repeatedly performed for each control cycle time which is described above.

First, the obstacle recognizer 132 recognizes an obstacle in the traveling direction of the host vehicle M (Step S100) and the traveling lane recognizer 134 recognizes the relative position of the traveling lane with respect to the host vehicle M (Step S102).

Then, the candidate point setter 141 sets candidate points (Step S104) and sets a plurality of temporary trajectory in which the candidate points are connected in the longitudinal direction (Step S106).

Then, the first index deriver 142, the second index deriver 143, and the third index deriver 144 derive a first index R_{Path}, a second index B_{Path}, and the third indices C1 to C3, respectively, for each temporary trajectory (Step S108).

Then, the target trajectory generator 145 calculates the score for each temporary trajectory (Step S110) and sets a temporary trajectory with the smallest score as a target trajectory (Step S112).

The automated driving control device 100 according to the first embodiment described above includes the obstacle recognizer 132 configured to recognize an obstacle which is located near the host vehicle M and the target trajectory generator 145 configured to generate a target trajectory in which the host vehicle M is to travel repeatedly with a predetermined cycle time, and the target trajectory generator 145 is configured to generate the target trajectory such that a first change which is an amount of change in a road width direction from the target trajectory which is generated in a previous cycle time during repeated execution and a second change which is an amount of change of a direction with respect to a direction directed from the vehicle to a point a predetermined distance away on the target trajectory between the previous cycle time and a current cycle time are decreased. Accordingly, it is possible to flexibly generate a target trajectory in various scenes.

According to another aspect, the automated driving control device 100 according to the first embodiment includes the obstacle recognizer 132 configured to recognize an obstacle which is located near the host vehicle M, the first index deriver 142 configured to derive a first index R which has a more negative value as the vehicle becomes closer to the recognized obstacle for each of a plurality of candidate points cK in a traveling direction of the vehicle, the second index deriver 143 configured to derive a second index B which has a more positive value as the vehicle becomes closer to a recommended trajectory rT which is set in a predetermined rule for each of the plurality of candidate points in the traveling direction of the host vehicle M, the third index deriver 144 configured to derive a third index which is obtained by evaluating a shape of a temporary trajectory connecting the plurality of candidate points cK in a road length direction, and the target trajectory generator 145 configured to generate a target trajectory in which the host vehicle M is to travel, and the target trajectory generator 145 is configured to generate a temporary trajectory in which a score based on the first index R and the second index B correlated with a plurality of candidate points included in the temporary trajectory and the third index derived for the temporary trajectory has a positive value out of a plurality of the temporary trajectories as the target trajectory. Accordingly, it is possible to flexibly generate a target trajectory in various scenes.

### Second Embodiment

A second embodiment will be described below. In the first embodiment, setting of a temporary trajectory is not particularly limited, but in the second embodiment, when an upper limit is provided in the distance ΔY1 (see FIG. 8) in the lateral direction between candidate points cK adjacent in the longitudinal direction and there is any distance ΔY1 greater than the upper limit, the corresponding temporary trajectory is excluded from candidates for a target trajectory. Here, it is assumed that the distance does not have a directional element. That is, a process of excluding a temporary trajectory including a part in which the distance ΔY1 is greater than a threshold value Th_{Y} from calculation targets of the score in advance is performed as a pre-process. Accordingly, it is possible to further decrease a probability of sudden turning of the host vehicle M.

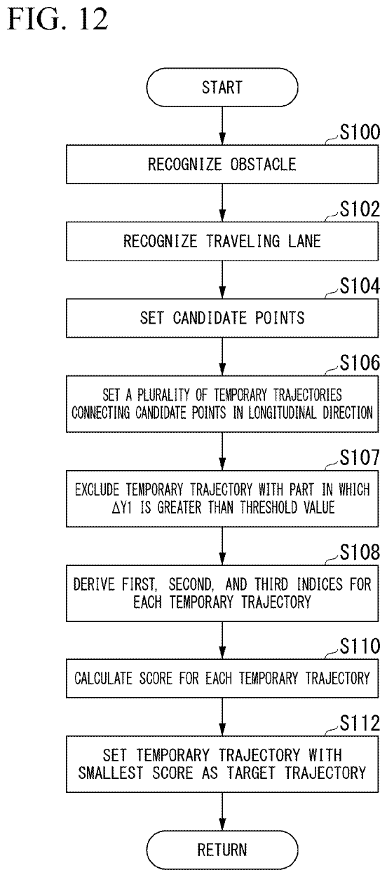

FIG. 12 is a flowchart illustrating an example of a process flow which is performed by the first controller 120 according to the second embodiment. The process flow in the flowchart is repeatedly performed for each control cycle time which is described above. The processes of Steps S100 to S106 and the processes of Steps S108 to S112 are the same as described above with reference to FIG. 11 and description thereof will be omitted.

Subsequent to the process of Step S106, the candidate point setter 141 excludes a temporary trajectory including a part in which the distance ΔY1 is greater than the threshold value Th_{Y} from temporary trajectories connecting candidate points in the longitudinal direction (Step S107).

First, instead of comprehensively setting temporary trajectories and excluding a temporary trajectory in which every distance ΔY1 is greater than the threshold value Th_{Y}, a search range (a search angle) may be limited such that the distance ΔY1 is not greater than the threshold value Th_{Y} when the temporary trajectories are sequentially searched from an end in the longitudinal direction.

According to the second embodiment described above, it is possible to achieve the same advantages as in the first embodiment and to further decrease a probability of sudden turning of the host vehicle M. Since the process of calculating the score is performed after the temporary trajectories are narrowed, it is possible to decrease a process load.

### Third Embodiment

A third embodiment will be described below. In the third embodiment, the target trajectory generator 145 ascertains whether a target trajectory selected on the basis of a score includes a part in which the distance ΔY1 is greater than the threshold value Th_{Y}, and corrects the target trajectory such that the distance ΔY1 becomes equal to or less than the threshold value Th_{Y} when there is a part in which the distance ΔY1 is greater than the threshold value Th_{Y}.

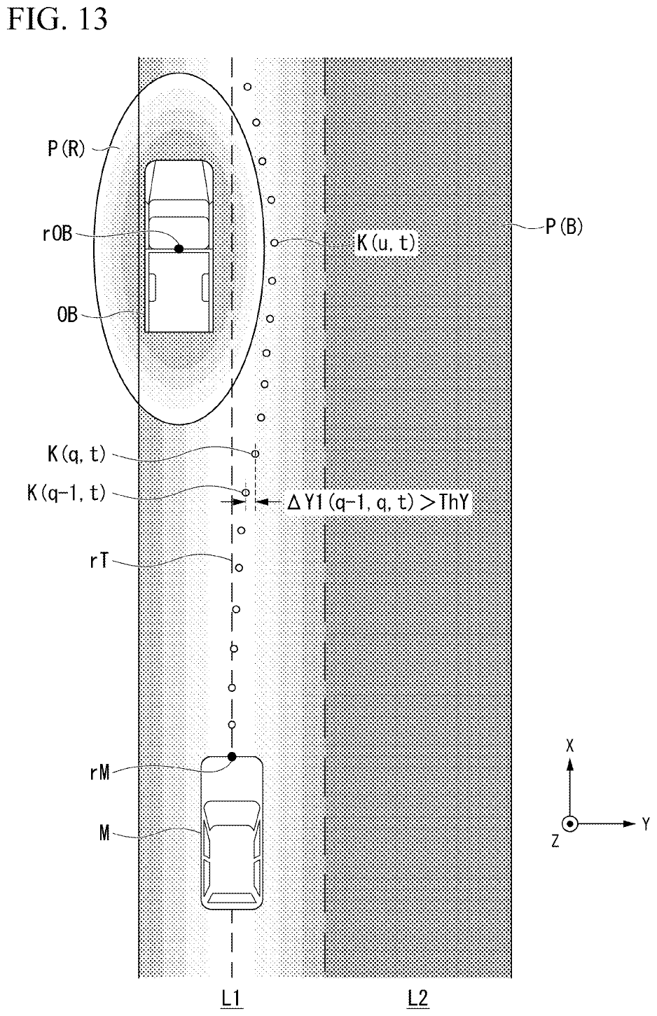

FIG. 13 is a diagram illustrating a process flow which is performed by the target trajectory generator 145 according to the third embodiment. In the drawing, a q-th trajectory point K(q, t) and a (q−1)-th trajectory point K(q−1, t) have a relationship in which the distance ΔY1 in the lateral direction therebetween is greater than the threshold value Th_{Y}. Since the target trajectory has been generated already, the points are referred to as “trajectory points K” instead of “candidate points cK.” In the distance ΔY1 in the third embodiment, candidate points are replaced with trajectory points.

In this case, for example, the target trajectory generator 145 selects an obstacle which is closest to the trajectory point K and corrects the position of the q-th trajectory point K(q, t) or the (q−1)-th trajectory point K(q−1, t) in the lateral direction such that the trajectory point K becomes further away from the representative point of the obstacle. In the example illustrated in FIG. 13, since a representative point rOB of an obstacle OB is located on the left side when seen from a trajectory point K(q), the target trajectory generator 145 moves the position of the (q−1)-th trajectory point K(q−1, t) in a direction in which it becomes further away from the representative point rOB of the obstacle OB, that is, to the right. The target trajectory generator 145 sets, for example, an amount of movement thereof to a minimum amount of movement in which the distance ΔY1 is not greater than the threshold value Th_{Y}. As a result of this process, when the distance in the lateral direction between the (q−1)-th trajectory point K(q−1, t) and the (q−2)-th trajectory point K(q−2, t) is greater than the threshold value Th_{Y}, the target trajectory generator 145 moves the (q−2)-th trajectory point K(q−2, t) to the right. The target trajectory generator 145 according to the third embodiment repeatedly performs this process in a spreading manner until all the distances ΔY1 are equal to or less than the threshold value Th_{Y}.

In this process, it is necessary to determine a trajectory point K at which the distance ΔY1 is first ascertained. If this trajectory point is not determined, there is a likelihood that the process will spread from both sides and will not converge. For example, the target trajectory generator 145 according to the third embodiment sets a trajectory point K with the largest amount of displacement in the lateral direction from the base path (a u-th trajectory point K(u, t) in FIG. 13) as a search start point and ascertains whether the distance ΔY1 is greater than the threshold value ThY to both a near side (a side getting closer to the host vehicle M) and a distant side (a side getting further away from the host vehicle M) from the search start point.

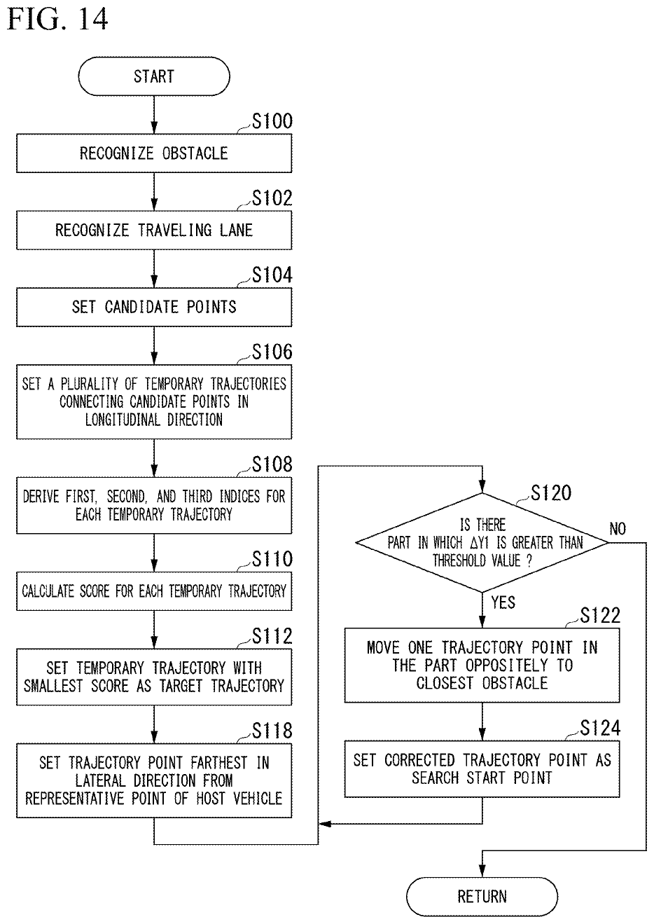

FIG. 14 is a flowchart illustrating an example of a process flow which is performed by the first controller 120 according to the third embodiment. The process flow in the flowchart is repeatedly performed for each control cycle which is described above. The processes of Steps S100 to S112 are the same as described above with reference to FIG. 11 and description thereof will be omitted.

When a target trajectory is generated, the target trajectory generator 145 sets a trajectory point which is the most distant in the lateral direction from the representative point rM of the host vehicle M as a search start point (Step S118). Then, the target trajectory generator 145 sequentially determines whether there is a part in which the distance ΔY1 is greater than the threshold value Th_{Y} to both the near side and the distant side from the search start point (Step S120). When it is determined that there is a part in which the distance ΔY1 is greater than the threshold value Th_{Y}, the target trajectory generator 145 moves some trajectory points of the part to the side opposite to the closest obstacle to correct the target trajectory (Step S122). Then, the target trajectory generator 145 sets the corrected trajectory point as the search start point (Step S124) and performs the process of Step S120 again (Step S120). Here, search to the sides opposite to the near side and the distant side is not performed. When there is no part in which the distance ΔY1 is greater than the threshold value Th_{Y}, processing of one control cycle of the flowchart ends.

According to the third embodiment described above, it is possible to achieve the same advantages as in the first embodiment and to further decrease a probability of sudden turning of the host vehicle M.

Hardware Configuration

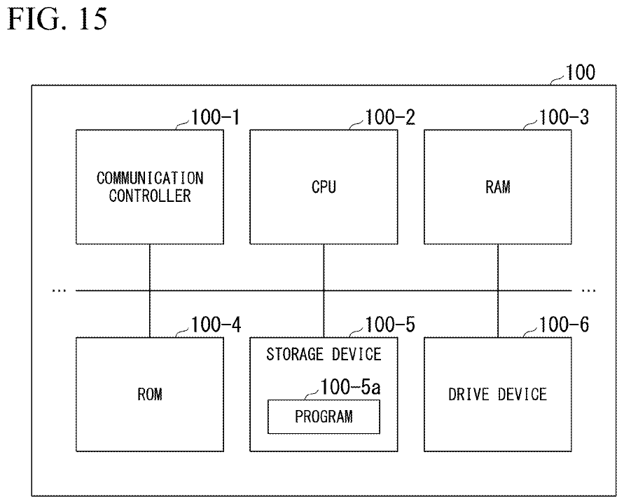

FIG. 15 is a diagram illustrating an example of a hardware configuration of the automated driving control device 100 according to the embodiment. As illustrated in the drawing, the automated driving control device 100 has a configuration in which a communication controller 100-1, a CPU 100-2, a random access memory (RAM) 100-3 that is used as a work memory, a read only memory (ROM) 100-4 that stores a booting program or the like, a storage device 100-5 such as a flash memory or a hard disk drive (HDD), a drive device 100-6, and the like are connected to each other via an internal bus or a dedicated communication line. The communication controller 100-1 communicates with elements other than the automated driving control device 100. A program 100-5a which is executed by the CPU 100-2 is stored in the storage device 100-5. This program is loaded into the RAM 100-3 by a direct memory access (DMA) controller (not illustrated) or the like and is executed by the CPU 100-2. Accordingly, one or both of the first controller 120 and the second controller 160 are embodied.

The above embodiment can be described as follows:

a vehicle control device including:

a storage device that stores a program; and

a hardware processor,

wherein, by executing the program stored in the storage device, the hardware processor is configured to perform:

recognizing an obstacle which is located near a vehicle;

generating a target trajectory in which the vehicle is to travel repeatedly with a predetermined cycle; and

generating the target trajectory such that a first change which is an amount of change in a road width direction from the target trajectory which is generated in a previous cycle during the repeated generating of the target trajectory and a second change which is an amount of change of a direction with respect to a direction directed from the vehicle to a point a predetermined distance away on the target trajectory between the previous cycle and a current cycle are decreased.

The above embodiment can also be described as follows:

a vehicle control device including:

a storage device that stores a program; and

a hardware processor,

wherein, by executing the program stored in the storage device, the hardware processor is configured to perform:

recognizing an obstacle which is located near a vehicle;

deriving a first index which has a more negative value as the vehicle becomes closer to the recognized obstacle for each of a plurality of candidate points in a traveling direction of the vehicle;

deriving a second index which has a more positive value as the vehicle becomes closer to a recommended trajectory which is set in a predetermined rule for each of the plurality of candidate points in the traveling direction of the vehicle;

deriving a third index which is obtained by evaluating a shape of a temporary trajectory connecting the plurality of candidate points in the road length direction;

generating a target trajectory in which the vehicle is to travel; and

generating a temporary trajectory in which a score based on the first index and the second index correlated with a plurality of candidate points included in the temporary trajectory and the derived third index has a positive value out of a plurality of the temporary trajectories as the target trajectory at the time of generating the target trajectory.

While the invention has been described above with reference to an embodiment, the invention is not limited to the embodiment and can be subjected to various modifications and substitutions without departing from the gist of the invention.

What is claimed is:

1. A vehicle control device comprising:
an obstacle recognizer configured to recognize an obstacle which is located near a vehicle; and
a target trajectory generator configured to generate a target trajectory in which the vehicle is to travel repeatedly with a predetermined cycle time,
wherein the target trajectory generator is configured to generate the target trajectory such that a first change which is an amount of change in a road width direction from the target trajectory which is generated in a previous cycle during repeated execution and a second change which is an amount of change of a direction with respect to a direction directed from the vehicle to a point a predetermined distance away on the target trajectory between the previous cycle and a current cycle are decreased.

2. The vehicle control device according to claim 1,
wherein the target trajectory generator is configured to generate the target trajectory such that a distance in the road width direction between candidate points adjacent to each other in a road length direction out of candidate points which segments the target trajectory at a pitch of a predetermined distance is decreased.

3. The vehicle control device according to claim 1, further comprising:
a first index deriver configured to derive a first index which has a more negative value as the vehicle becomes closer to the recognized obstacle for each of a plurality of candidate points in a traveling direction of the vehicle;
a second index deriver configured to derive a second index which has a more positive value as the vehicle becomes closer to a recommended trajectory which is set in a predetermined rule for each of the plurality of candidate points in the traveling direction of the vehicle; and
a third index deriver configured to derive a third index which is obtained by evaluating a shape of a temporary trajectory connecting the plurality of candidate points in a road length direction on the basis of at least the first change and the second change,
wherein the target trajectory generator is configured to generate a temporary trajectory in which a score based on the first index and the second index correlated with a plurality of candidate points included in the temporary trajectory and the third index derived for the temporary trajectory has a positive value out of a plurality of temporary trajectories as the target trajectory.

4. A vehicle control device comprising:
an obstacle recognizer configured to recognize an obstacle which is located near a vehicle;
a first index deriver configured to derive a first index which has a more negative value as the vehicle becomes closer to the recognized obstacle for each of a plurality of candidate points in a traveling direction of the vehicle;
a second index deriver configured to derive a second index which has a more positive value as the vehicle becomes closer to a recommended trajectory which is set in a predetermined rule for each of the plurality of candidate points in the traveling direction of the vehicle;
a third index deriver configured to derive a third index which is obtained by evaluating a shape of a temporary trajectory connecting the plurality of candidate points in the road length direction; and
a target trajectory generator configured to generate a target trajectory in which the vehicle is to travel,
wherein the target trajectory generator is configured to generate a temporary trajectory in which a score based on the first index and the second index correlated with a plurality of candidate points included in the temporary trajectory and the third index derived for the temporary trajectory has a positive value out of a plurality of the temporary trajectories as the target trajectory.

5. The vehicle control device according to claim 4,
wherein the third index deriver is configured to derive the third index such that the third index has a more positive value as a distance in a road width direction between candidate points adjacent to each other in the road length direction becomes less for the plurality of candidate points included in the temporary trajectory.

6. The vehicle control device according to claim 4,
wherein the target trajectory generator is configured to generate the target trajectory repeatedly with a predetermined cycle, and
wherein the third index deriver is configured to derive the third index such that the third index has a more positive value as a distance in a road width direction between corresponding points in the road length direction in the target trajectory which is generated in a previous cycle and the temporary trajectory becomes less.

7. The vehicle control device according to claim 4,
wherein the target trajectory generator is configured to generate the target trajectory repeatedly with a predetermined cycle, and
wherein the third index deriver is configured to derive the third index such that the third index has a more positive value as a slope of change of a straight line connecting a position of the vehicle at a time point of generation of the temporary trajectory and a predetermined-numbered candidate point form a candidate point closest to the vehicle in the temporary trajectory between a previous cycle and a current cycle becomes less.

8. The vehicle control device according to claim 4,
wherein the third index deriver is configured not to derive the third index from a temporary trajectory in which a distance in a road width direction between candidate points adjacent to each other in the road length direction is greater than a threshold value.

9. The vehicle control device according to claim 1,
wherein the target trajectory generator is configured to move one of two candidate points in which a distance in the road width direction is greater than a threshold value in the road width direction such that the distance is not greater than the threshold value when the distance in the road width direction between candidate points which constitute the generated target trajectory and are adjacent to each other in a road length direction is greater than the threshold value.

10. The vehicle control device according to claim 9,
wherein the target trajectory generator is configured to set a search start point which is used to ascertain whether the distance in the road width direction between candidate points adjacent to each other in the road length direction is greater than the threshold value to a trajectory point which is farthest from the vehicle in the road width direction out of trajectory points constituting the target trajectory.

11. A vehicle control method of causing a computer mounted in a vehicle to perform:
recognizing an obstacle which is located near the vehicle;
generating a target trajectory in which the vehicle is to travel repeatedly with a predetermined cycle; and
generating the target trajectory such that a first change which is an amount of change in a road width direction from the target trajectory which is generated in a previous cycle during repeated generating of the target trajectory and a second change which is an amount of change of a direction with respect to a direction directed from the vehicle to a point a predetermined distance away on the target trajectory between the previous cycle and a current cycle are decreased.

12. A vehicle control method of causing a computer mounted in a vehicle to perform:
recognizing an obstacle which is located near the vehicle;
deriving a first index which has a more negative value as the vehicle becomes closer to the recognized obstacle for each of a plurality of candidate points in a traveling direction of the vehicle;
deriving a second index which has a more positive value as the vehicle becomes closer to a recommended trajectory which is set in a predetermined rule for each of the plurality of candidate points in the traveling direction of the vehicle;
deriving a third index which is obtained by evaluating a shape of a temporary trajectory connecting the plurality of candidate points in the road length direction;
generating a target trajectory in which the vehicle is to travel; and
generating a temporary trajectory in which a score based on the first index and the second index correlated with a plurality of candidate points included in the temporary trajectory and the third index derived for the temporary trajectory has a positive value out of a plurality of the temporary trajectories as the target trajectory at the time of generating the target trajectory.
